(19) United States
(12) Patent Application Publication
(10) Pub. No.: US 2024/0098327 A1
(43) Pub. Date: Mar. 21, 2024

(54) COMPUTER IMPLEMENTED SYSTEM AND METHOD FOR ON DEMAND CONTENT CONTROL OF INDIVIDIALIZED PRODUCTION PLAN TO BE IMPLEMENTED IN LIVE PERFORMANCE VENUE TO USER WIRELESS COMPUTING DEVICES ASSOCIATED WITH SOCIAL MEDIA USERS AND LIVE AUDIENCE.

(71) Applicant: NEW HEAVY ENT LLC, Columbus, GA (US)

(72) Inventor: James Isaac Brown, Columbus, GA (US)

(21) Appl. No.: 18/470,990

(22) Filed: Sep. 20, 2023

Related U.S. Application Data
(63) Continuation of application No. 63/376,369, filed on Sep. 20, 2022.

(51) Int. Cl. H04N 21/266; H04N 21/2543

(52) U.S. Cl. CPC H04N 21/266; H04N 21/2543

(57) ABSTRACT

A computer-implemented method, system, and computer readable medium comprising executable instructions, to control content of a production plan to be implemented at a performance venue may include, configuring a plurality of a user wireless computing device to execute a user mobile application and performing production content management instructions to perform: first providing production plan information to the user mobile application; first receiving a proposed content control request from the application; first determining a content control decision in relation to said proposed content control request notice of the decision; incorporating a content control action in relation to the production plan; and providing, to the user mobile application, an implementation of the performance plan incorporating the content control action.

### CROSS-REFERENCE TO RELATED APPLICATIONS

This application is related and claims priority to U.S. Provisional Application 63/376369 filed Sep. 20, 2022, which is incorporated by reference in entirety.

### FIELD OF THE INVENTION

The disclosure relates generally to computer-implemented systems, apparatuses, and methods, and computer executable instructions, for providing performances to users of social media platforms, live audiences, or both.

### BACKGROUND OF THE INVENTION

The disclosure relates to computer-implemented systems, apparatuses, and methods, and computer executable instructions, for providing live performances to users of social media platforms and live audiences. More particularly, the disclosure relates to providing individualized performances on demand to users of social media platforms, live audience attendees, or both. Such computer-implemented systems may include wireless communication devices (“wireless devices”), wired computing devices, or both, configured for communications over packetized communications networks such as, for example, mobile phone communication networks, private networks, public networks, network infrastructure, and the Internet. Suitable wireless devices, for example, may include smartphones, smart watches, IoT devices, and tablet computing devices. Although embodiments disclosed herein primarily relate to connecting users of social media, it is to be understood that the disclosed systems, apparatuses, and methods may have application in relation to users of wireless devices who are not users of a social media platform.

Users of social media platforms, and individuals in live audiences at a performance venue, for watching or listening to performances, have no systemic capabilities or system channels, or extremely limited systemic capabilities or system channels, to communicate with performing talent, writers, or production managers in a timely, meaningful manner that might influence, customize, or modify content of a particular live performance in a predictable way. These limits are implemented for efficiency in management of resources and production of performances, in the interest of providing artistic integrity, and out of concern for safety, privacy, and security of personnel.

The value of using a social media platform, a live performance venue, or both, may be increased by providing a system, and method, wherein systemic capabilities or system channels may facilitate opportunities for social media users, individuals in live audiences, or both, to communicate with performing talent, writers, or production managers in a timely, meaningful manner that may influence, change, or modify content to be performed in a particular live performance, in a predictable way. Such a system, and method, may enable timely influencing, changing, or modifying of content to be performed in a live performance in a predictable way, in relation to perceived quality of content, scope of content, or both. Such a system, and method, may enable timely influencing, changing, or modifying of content to be performed in a live performance in a predictable way, in relation to improving precision of content in a timely manner in relation to preferences expressed by social media users, individuals in live audiences, or both. For reasons stated above and for other reasons which will become apparent to those skilled in the art upon reading and understanding the present specification, there is a need in the art for improved social media platforms and live performance venues that facilitate opportunities for social media users, individuals in live audiences, or both, to communicate with performing talent, writers, or production managers in a timely, meaningful manner that might influence, customize, or modify content of a particular live performance in a predictable way, and in a manner that can provide efficiency in management of resources and production of performances, preserve or enable artistic integrity, and without reducing safety, privacy and security of personnel.

### BRIEF DESCRIPTION OF THE INVENTION

The above-mentioned shortcomings, disadvantages and problems are addressed herein, as will be understood by those skilled in the art upon reading and studying the following specification. This Brief Description is provided to introduce a selection of concepts in a simplified form that are further described below in more detail in the Detailed Description. This Brief Description is not intended to identify key or essential features of the claimed subject matter.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In an aspect, a social media platform system, and method, may be configured to, and may be capable of, providing increased value of using a social media platform, a live performance venue, or both, wherein systemic capabilities or system channels may facilitate opportunities for social media users, individuals in live audiences, or both, to communicate with performing talent, writers, or production managers in a timely, meaningful manner that may influence, change, or modify content to be performed in a particular live performance, in a predictable way. In an aspect, a social media platform system, and method, may be configured to, and may be capable of, enabling timely influencing, changing, or modifying of content to be performed in a live performance in a predictable way, in relation to perceived quality of content, scope of content, or both. In an aspect, a social media platform system, and method, may be configured to, and may be capable of, enabling timely influencing, changing, or modifying of content to be performed in a live performance in a predictable way, in relation to improving precision of content in a timely manner in relation to preferences expressed by social media users, individuals in live audiences, or both.

Apparatus, systems, and methods of varying scope are described herein. These aspects are indicative of various non-limiting ways in which the disclosed subject matter may be utilized, all of which are intended to be within the scope of the disclosed subject matter. In addition to the aspects and advantages described in this summary, further aspects, features, and advantages will become apparent by reference to the associated drawings, detailed description, and claims.

### BRIEF DESCRIPTION OF THE DRAWINGS

The disclosed subject matter itself, as well as further objectives, and advantages thereof, will best be illustrated by reference to the following detailed description of embodiments of the device read in conjunction with the accompanying drawings, wherein:

FIG. 1 is a simplified block diagram of a system for providing predictable individualized performance content in entertainment productions to be consumed by social media users, individuals in a live audience of a performance venue, or both, in an exemplary embodiment; and

FIG. 2 is a simplified flow diagram of a method for providing predictable individualized performance content in entertainment productions to be consumed by social media users, individuals in a live audience of a performance venue, or both, in an exemplary embodiment.

### DETAILED DESCRIPTION OF THE INVENTION

The following detailed description, reference is made to the accompanying drawings which form a part hereof, and in which is shown by way of illustration specific embodiments which may be practiced. These embodiments are described in sufficient detail to enable those skilled in the art to practice the embodiments and disclosure. It is to be understood that other embodiments may be utilized, and that logical, mechanical, electrical, and other changes may be made without departing from the scope of the embodiments and disclosure. In view of the foregoing, the following detailed description is not to be taken as limiting the scope of the embodiments or disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be appreciated that for simplicity and clarity of illustration, where considered appropriate, reference numerals may be repeated among the figures to indicate corresponding or analogous elements. In addition, numerous specific details are set forth in order to provide a thorough understanding of the implementations described herein. However, it will be understood by those of ordinary skill in the art that the implementations described herein may be practiced without these specific details. In other instances, well-known methods, procedures and components have not been described in detail so as not to obscure the implementations described herein. Also, the description is not to be considered as limiting the scope of the implementations described herein.

The detailed description set forth herein in connection with the appended drawings is intended as a description of exemplary embodiments in which the presently disclosed apparatus and system can be practiced. The term “exemplary” used throughout this description means “serving as an example, instance, or illustration,” and should not necessarily be construed as preferred or advantageous over other embodiments.

The terms “upper”, “top”, “lower”, “bottom”, “vertical”, “horizontal”, etc., are used for convenience to refer to the relative orientation of apparatus and are not intended to otherwise limit the structures described and claimed. The terms “axial”, “axially”, “longitudinal”, “longitudinally”, etc., refer to relative orientation, dimensions or both, of apparatus and are not intended to otherwise limit the structures described and claimed. The terms “radial”, “radially”, “lateral”, “laterally”, etc., refer to relative orientation, dimensions or both, of apparatus and are not intended to otherwise limit the structures described and claimed. The terms “angle”, “angular”, “rotationally”, etc., unless otherwise stated refer to relative orientation, dimensions or both, of apparatus and are not intended to otherwise limit the structures described and claimed. The terms “attach”, “attachment”, etc., pertain to engagement between assembled distinct parts of an assembly, which may be attached to each other, or detached from each other. The terms “lock”, “locking”, etc., pertain to preventing inadvertent displacement or detachment between parts of an assembly.

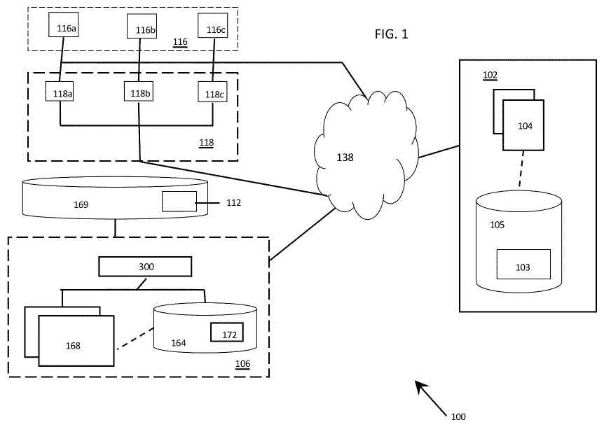

FIG. 1 is a simplified block diagram of a computer-implemented production management system 100 (or “system” 100) to control content of a production plan 102. Production plan 102 may comprise computer-implemented instructions 103 in an accessible medium 105, which may be executable by a processor 104. Production plan 102 may include a instructions, content, controls, or a representation, which may be individualized or customized, of a script or planned performance to be implemented. Production plan 102 may include computer-executable instructions such as, for example, all or part of computer-executable instructions of an implementation of a production plan to be implemented in relation to a performance venue. The production plan executable instructions or steps, and implementation therefore, may be executable in relation to a script of a performance. In an embodiment, such a script in relation to a production plan also may be physically implemented, or performed, by a cast of performers at a physical performance venue. An implementation of the production plan 102 may be provided to an audience population, which may include a population of user wireless computing devices 118a, 118b, 118c (generally “118”) accessible and in use by live audience attendees at the performance venue, a plurality of online viewers, such as a plurality of users of a social media platform, or both. In embodiments, for example, an implementation may include audio elements, video elements, or both. The system 100, by controlling content of production plan 102, may provide predictable, individualized or customized production content of an entertainment production to be viewed, or consumed, by social media users, individuals in a live audience of a performance venue, or both, in an exemplary embodiment. In the particular exemplary embodiment shown in FIG. 1., production management system 100 may be independent of, and complementary to, a plurality of other social media online systems. In other embodiments (not shown), a production management system as disclosed herein may be part of a general social media online system. Production management system 100 may include a production management server 106 configured to, and capable of, facilitating control of a production plan 102. As described elsewhere herein, production plan 102 may include customized or individualized production plan content 103, which may relate to a plurality of user mobile application clients (“mobile application client,” “application client,” “mobile application,” or “user mobile application”) 116a, 116b, 116c (generally, “116”) operable on respective of a plurality of user wireless computing devices 118 (“wireless devices” or “user wireless devices”) for enabling and controlling production plan 102, and implementations of a production plan 112. Such enabling and controlling production plan 102, and implementations 112 of production plan 102, may include enabling control of the initiating, producing, performing and reporting of an individualized, customized portion of production plan content, in an exemplary embodiment. The production management server 106 may facilitate the configuration of the individualized portion of content of production plan 102, and implementations 112 of production plan 102, in relation to information regarding the plurality of user wireless devices 118. The production management server 106 may facilitate user control or input, such as user choices, of selectable aspects of individualized content of production plan 102. It will be understood that individualized content of production plan 102 may comprise data structures including user-facing information, which may include user selectable elements and server-controlled elements such as, for example, platform rules. User selectable elements may include, for example, production content information including performance schedule, timing, playlists, dialogue, monologue, emcee availability, emcee content, performer content, lighting conditions, sound conditions, performance breaks, intermissions, and variables of the aforementioned. In an embodiment, for example, individualized production content information may include an individual's name, where the named individual is individualized or customized production plan content, who is a subject of a production content control request. The plurality of mobile application clients 116 installed on user wireless devices 118, for example, may include a plurality of first user wireless device 118 configured to provide or perform individualized production content control. The plurality of mobile application clients 116 installed on user wireless devices 118, for example, also may include one, or a plurality of, production wireless device in an individualized performance content management role. In embodiments, the production management server 106, for example, may facilitate user control of individualized production content of production plan 102. In embodiments, the production management server 106, for example, may include production management constraints of individualized content of production plan 102.

System 100 may include the plurality of user wireless communications devices 118 (“wireless devices”) capable of data communications such as text messaging (SMS) communications, voice communications, and exchange of packetized data according to a suitable communication protocol (such as, for example, Internet Protocol (IP)) over a communications network 138. For purposes of this description, the plurality of wireless devices 118 may be characterized as including enumerated user devices such as a first user wireless device 118a, a second user wireless device 118b, third user wireless device 118c, and so on. Communications network 138 may include one or a plurality of interconnected wireless communication networks capable of enabling operations of smartphones and IP-enabled devices of smart wireless devices such as wireless tablet computers, smart watches, and IoT devices. Communications network 138 may include network infrastructure, such as hardware, software, links, logical connections, and the Internet, enabling communications by any suitable communication protocols.

System 100 may include production management server 106 configured and operable for communications over the communications network 138 with the plurality of user mobile application clients 116 installed on respective of a plurality of user wireless devices 118. Production management server 106 may include accessible memory 164 capable of storing executable instructions or steps, one or more processors or processor resources 168 (“processor”) operable to execute the instructions to perform production content management or control functions, system storage 169, a network interface, and input/output interfaces. The production management server 106 and components thereof may be implemented as a virtual machine and may be implemented by a cloud server resource. One or more implementations 112 of production plan 102, which may include generated audio, video, or both, of production plan 102, may be stored or recorded in accessible form in system storage 169.

Referring to FIG. 1, a production management system 100 may be operable to control content of a production plan 102 to be implemented at a performance venue. Such system 100 may include an audience population comprising a plurality of a user wireless computing device 118. Each of the plurality of user wireless computing devices 118 may enable communications on communications network 138. Each of the plurality of user wireless computing devices 118 is operable to execute a respective user mobile application 116.

Referring to FIG. 1, a production management system 100 may include a production content management server 106 accessible on the communication network 138 by the plurality of user wireless computing devices 118. In an embodiment, production content management server 106 may include a processor 168 and a memory 164 coupled to the processor 168, the memory 164 comprising instructions executable by the processor. The instructions may comprise production management instructions, production content management instructions, or both (collectively “production content management instructions 172). The production content management instructions 172 may be configured to perform or execute a computer-implemented method 300 by operations of the processor and memory combination.

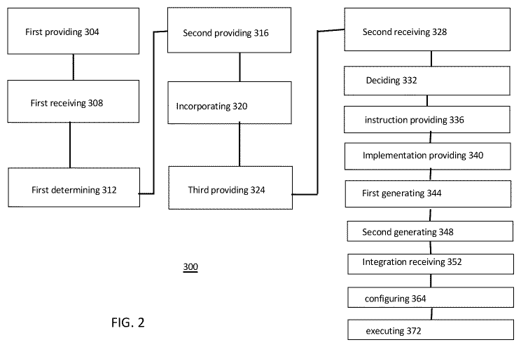

In an embodiment, a computer-implemented method 300, described in further detail elsewhere herein, to control content of a production plan to be implemented, or performed, by a cast of performers at a performance venue. In an embodiment, such computer-implemented method 300 may be performed by a system to control content of a production plan to be implemented, or performed, by a cast of performers at a performance venue, such as, for example, system 100 described elsewhere herein. In an embodiment, all or some steps of such computer-implemented method 300 may be performed by an exemplary system 100 or similar system. In an embodiment, for example, method 300 may include first providing 304, to the user mobile application, production plan information of the production plan. In an embodiment, for example, method 300 may include first receiving 308, from the user mobile application, a proposed content control request in relation to said production plan information. In an embodiment, for example, method 300 may include first determining 312, in relation to said proposed content control request in relation to said production plan information, a content control decision. In an embodiment, for example, method 300 may include second providing 316, to said user mobile application in relation to said content control decision, notice of said content control decision. In an embodiment, for example, method 300 may include incorporating 320 in relation to said content control decision, a content control action in relation to the production plan. In an embodiment, for example, method 300 may include third providing 324, to said user mobile application in relation to said content control action, an implementation of the performance plan incorporating said content control action. In an embodiment, for example, method 300 may include second receiving 328, from a payment processor, notice of payment. In an embodiment, for example, method 300 may further include, in the aforementioned second receiving 328 or separately therefrom as shown in FIG. 2, in relation to notice of payment, deciding 332 a content control payment decision in relation to said proposed content control request. In an embodiment, for example, method 300 may further include, in the aforementioned incorporating 320 or separately therefrom as shown in FIG. 2, instruction providing 336 to the production plan said content control action comprising a production plan customization instruction, the production plan to be implemented with said production plan customization instruction. In an embodiment, for example, method 300 may further include, in the aforementioned third providing 324 or separately therefrom as shown in FIG. 2, implementation providing 340, to said user mobile application in relation to said content control action, said implementation of the production plan incorporating said content control action comprising said production plan customization instruction, the production plan implemented with said production plan customization instruction.

In an embodiment, for example, method 300 may further include the user wireless computing device configured to perform first generating 344, by said user wireless computing device operating to execute said user mobile application, audio output of said implementation of the performance plan incorporating said content control action comprising said production plan customization instruction, the production plan implemented with said production plan customization instruction. In an embodiment, for example, method 300 may further include the user wireless computing device configured to perform second generating 348, by said user wireless computing device operating to execute said user mobile application, video output of said implementation of the performance plan incorporating said content control action comprising said production plan customization instruction, the production plan implemented with said production plan customization instruction.

In an embodiment, for example, method 300 may further include said production content management instructions configured to perform, in said incorporating 320 or separately therefrom as shown in FIG. 2, integration receiving 352 by said user wireless computing device in response to a user input prompt generated by execution of said user mobile application, the integrated production plan to be implemented with said production plan customization instruction comprising said user customization instruction integrated therein. The production plan customization instruction may comprise a user customization instruction. In an embodiment, for example, method 300 may further include said production content management instructions configured to perform, in said incorporating 320 or separately therefrom, the production plan to be implemented with said production plan customization instruction comprising the user customization instruction further comprising name information of a designated individual. In an embodiment, the designated individual identified in said user customization instruction in relation to a designated shout-out spot of the production plan.

In an embodiment, for example, method 300 may further include said production content management instructions configured to perform, in said incorporating 320 or separately therefrom, second receiving 328, from a payment processor, notice of payment. In an embodiment, for example, method 300 may further include, in the aforementioned determining 328 or separately therefrom as shown in FIG. 2, in relation to notice of payment, deciding 332 a content control payment decision in relation to said proposed content control request. In an embodiment, for example, method 300 may further include, in the aforementioned incorporating 320 or separately therefrom, instruction providing 336 to the production plan said content control action comprising a production plan customization instruction, the production plan to be implemented with said production plan customization instruction. In an embodiment, for example, method 300 may further include, in the aforementioned third providing 324 or separately therefrom as shown in FIG. 2, implementation providing 340, to said user mobile application in relation to said content control action, said implementation of the production plan incorporating said content control action comprising said production plan customization instruction, the production plan implemented with said production plan customization instruction. In an embodiment, for example, the production plan may be implemented with said production plan customization instruction comprising said user customization instruction, said user customization instruction comprising name information of a designated individual, the designated individual identified in said user customization instruction in relation to a designated shout-out spot of the production plan. In an embodiment, for example, the production plan may be implemented, whether in the aforementioned third providing 324 or separately therefrom, by further providing 356 to said user mobile application in relation to said content control action, said implementation of the production plan incorporating said content control action comprising said production plan customization instruction, the production plan implemented with said production plan customization instruction. As previously disclosed hereinabove, in an embodiment the user wireless computing device may be configured to perform first generating 344, by said user wireless computing device operating to execute said user mobile application, audio output of said implementation of the performance plan incorporating said content control action comprising said production plan customization instruction, the production plan implemented with said production plan customization instruction. Likewise, as previously disclosed hereinabove, in an embodiment the user wireless computing device may be configured to perform second generating 348, by said user wireless computing device operating to execute said user mobile application, video output of said implementation of the performance plan incorporating said content control action comprising said production plan customization instruction, the production plan implemented with said production plan customization instruction.

In an embodiment, for example, computer-implemented method 300, to control content of a production plan to be implemented at a performance venue, may further include configuring 364, an audience population comprising a plurality of a user wireless computing device to execute a user mobile application, the user wireless computing device enabling communications on a communication network, the user wireless computing device. In an embodiment, for example, computer-implemented method 300, to control content of a production plan to be implemented at a performance venue, may further include executing 372, by a production content management server accessible on the communication network by the user wireless computing device, all or some steps of method 300, such as production content management steps to control content of a production plan as elsewhere disclosed herein. The production content management server may include, for example, a processor; and a memory coupled to the processor, the memory comprising instructions executable by the processor. The production content management server may further include, for example, the instructions comprising production content management instructions. The production content management instructions may include, for example, instructions configured to perform some, or all, steps or instructions disclosed herein for method 300. In an embodiment, a computer readable medium may include processor executable instructions which, when executed in a processing system, causes the processing system to perform the steps of method 300.

Apparatus, methods and systems according to embodiments of the disclosure are described. Although specific embodiments are illustrated and described herein, it will be appreciated by those of ordinary skill in the art that any arrangement which is calculated to achieve the same purposes can be substituted for the specific embodiments shown. This application is intended to cover any adaptations or variations of the embodiments and disclosure. For example, although described in terminology and terms common to the field of art, exemplary embodiments, systems, methods and apparatus described herein, one of ordinary skill in the art will appreciate that implementations can be made for other fields of art, systems, apparatus or methods that provide the required functions. The invention should therefore not be limited by the above-described embodiment, method, and examples, but by all embodiments and methods within the scope and spirit of the invention.

In particular, one of ordinary skill in the art will readily appreciate that the names of the methods and apparatus are not intended to limit embodiments or the disclosure. Furthermore, additional methods, steps, and apparatus can be added to the components, functions can be rearranged among the components, and new components to correspond to future enhancements and physical devices used in embodiments can be introduced without departing from the scope of embodiments and the disclosure. One of skill in the art will readily recognize that embodiments are applicable to future systems, future apparatus, future methods, and different materials.

All methods described herein can be performed in a suitable order unless otherwise indicated herein or otherwise clearly contradicted by context. The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein. Terminology used in the present disclosure is intended to include all environments and alternate technologies that provide the same functionality described herein.

What is claimed is:

1. A system to control content of a production plan to be implemented at a performance venue said system comprising:
an audience population comprising a plurality of a user wireless computing device, the user wireless computing device enabling communications on a communication network, the user wireless computing device operable to execute a user mobile application, a production content management server accessible on the communication network by the user wireless computing device, said production content management server comprising:
a processor;
a memory coupled to the processor, the memory comprising instructions executable by the processor;
the instructions comprising production content management instructions configured to perform:
first providing, to the user mobile application, production plan information of the production plan;
first receiving, from the user mobile application, a proposed content control request in relation to said production plan information;
first determining, in relation to said proposed content control request in relation to said production plan information, a content control decision;
second providing, to said user mobile application in relation to said content control decision, notice of said content control decision;
incorporating, in relation to said content control decision, a content control action in relation to the production plan; and
third providing, to said user mobile application in relation to said content control action, an implementation of the performance plan incorporating said content control action.

2. A system according to claim 1 and further comprising:
said production content management instructions configured to perform:
second receiving, from a payment processor, notice of payment;
said first determining further comprising, in relation to said notice of payment, a content control payment decision in relation to said proposed content control request.

3. A system according to claim 1 and further comprising:
said production content management instructions configured to perform:
said incorporating further comprising:
providing to the production plan said content control action comprising a production plan customization instruction, the production plan to be implemented with said production plan customization instruction.

4. A system according to claim 3 and further comprising:
said production content management instructions configured to perform:
said third providing further comprising:
providing, to said user mobile application in relation to said content control action, said implementation of the production plan incorporating said content control action comprising said production plan customization instruction, the production plan implemented with said production plan customization instruction.

5. A system according to claim 4 and further comprising:
said user wireless computing device configured to perform:
first generating, by said user wireless computing device operating to execute said user mobile application, audio output of said implementation of the performance plan incorporating said content control action comprising said production plan customization instruction, the production plan implemented with said production plan customization instruction.

6. A system according to claim 5 and further comprising:
said user wireless computing device configured to perform:
second generating, by said user wireless computing device operating to execute said user mobile application, video output of said implementation of the performance plan incorporating said content control action comprising said production plan customization instruction, the production plan implemented with said production plan customization instruction.

7. A system according to claim 3 and further comprising:
said production content management instructions configured to perform:
said incorporating further comprising:
said production plan customization instruction comprising a user customization instruction received by said user wireless computing device in response to a user input prompt generated by execution of said user mobile application, the production plan to be implemented with said production plan customization instruction comprising said user customization instruction.

8. A system according to claim 7 and further comprising:
said production content management instructions configured to perform:
said incorporating further comprising:
the production plan to be implemented with said production plan customization instruction comprising said user customization instruction, said user customization instruction comprising name information of a designated individual, the designated individual identified in said user customization instruction in relation to a designated shout-out spot of the production plan.

9. A system according to claim 8 and further comprising:
said production content management instructions configured to perform:
second receiving, from a payment processor, notice of payment;
said first determining further comprising, in relation to said notice of payment, a content control payment decision in relation to said proposed content control request;
said incorporating further comprising:
the production plan to be implemented with said production plan customization instruction comprising said user customization instruction, said user customization instruction comprising name information of a designated individual, the designated individual identified in said user customization instruction in relation to a designated shout-out spot of the production plan;
said third providing further comprising:
providing, to said user mobile application in relation to said content control action, said implementation of the production plan incorporating said content control action comprising said production plan customization instruction, the production plan implemented with said production plan customization instruction.

10. A system according to claim 9 and further comprising:
said user wireless computing device configured to perform:
first generating, by said user wireless computing device operating to execute said user mobile application, audio output of said implementation of the performance plan incorporating said content control action comprising said production plan customization instruction, the production plan implemented with said production plan customization instruction.

11. A system according to claim 10 and further comprising:
said user wireless computing device configured to perform:
second generating, by said user wireless computing device operating to execute said user mobile application, video output of said implementation of the performance plan incorporating said content control action comprising said production plan customization instruction, the production plan implemented with said production plan customization instruction.

12. A computer-implemented method to control content of a production plan to be implemented at a performance venue said method comprising:
configuring, an audience population comprising a plurality of a user wireless computing device to execute a user mobile application, the user wireless computing device enabling communications on a communication network, the user wireless computing device;
performing, by a production content management server accessible on the communication network by the user wireless computing device, said production content management server comprising:
a processor;
a memory coupled to the processor, the memory comprising instructions executable by the processor;
the instructions comprising production content management instructions configured to perform:
first providing, to the user mobile application, production plan information of the production plan;
first receiving, from the user mobile application, a proposed content control request in relation to said production plan information;
first determining, in relation to said proposed content control request in relation to said production plan information, a content control decision;
second providing, to said user mobile application in relation to said content control decision, notice of said content control decision;
incorporating, in relation to said content control decision, a content control action in relation to the production plan; and
third providing, to said user mobile application in relation to said content control action, an implementation of the performance plan incorporating said content control action.

13. A computer-implemented method according to claim 12 and further comprising:
said production content management instructions configured to perform:
second receiving, from a payment processor, notice of payment;
said first determining further comprising, in relation to said notice of payment, a content control payment decision in relation to said proposed content control request.

14. A computer-implemented method according to claim 12 and further comprising:
said production content management instructions configured to perform:
said incorporating further comprising:
providing to the production plan said content control action comprising a production plan customization instruction, the production plan to be implemented with said production plan customization instruction.

15. A computer-implemented method according to claim 14 and further comprising:
said production content management instructions configured to perform:
said third providing further comprising:
providing, to said user mobile application in relation to said content control action, said implementation of the production plan incorporating said content control action comprising said production plan customization instruction, the production plan implemented with said production plan customization instruction.

16. A computer-implemented method according to claim 15 and further comprising:
said user wireless computing device configured to perform:
first generating, by said user wireless computing device operating to execute said user mobile application, audio output of said implementation of the performance plan incorporating said content control action comprising said production plan customization instruction, the production plan implemented with said production plan customization instruction.

17. A computer-implemented method according to claim 16 and further comprising:
said user wireless computing device configured to perform:
second generating, by said user wireless computing device operating to execute said user mobile application, video output of said implementation of the performance plan incorporating said content control action comprising said production plan customization instruction, the production plan implemented with said production plan customization instruction.

18. A computer-implemented method according to claim 14 and further comprising:
said production content management instructions configured to perform:
said incorporating further comprising:
said production plan customization instruction comprising a user customization instruction received by said user wireless computing device in response to a user input prompt generated by execution of said user mobile application, the production plan to be implemented with said production plan customization instruction comprising said user customization instruction.

19. A computer-implemented method according to claim 18 and further comprising:
said production content management instructions configured to perform:
said incorporating further comprising:
the production plan to be implemented with said production plan customization instruction comprising said user customization instruction, said user customization instruction comprising name information of a designated individual, the designated individual identified in said user customization instruction in relation to a designated shout-out spot of the production plan.

20. A computer-implemented method according to claim 19 and further comprising:
said production content management instructions configured to perform:
second receiving, from a payment processor, notice of payment;
said first determining further comprising, in relation to said notice of payment, a content control payment decision in relation to said proposed content control request;
said incorporating further comprising:
the production plan to be implemented with said production plan customization instruction comprising said user customization instruction, said user customization instruction comprising name information of a designated individual, the designated individual identified in said user customization instruction in relation to a designated shout-out spot of the production plan;
said third providing further comprising:
providing, to said user mobile application in relation to said content control action, said implementation of the production plan incorporating said content control action comprising said production plan customization instruction, the production plan implemented with said production plan customization instruction.

21. A computer-implemented method according to claim 20 and further comprising:
said user wireless computing device configured to perform:
first generating, by said user wireless computing device operating to execute said user mobile application, audio output of said implementation of the performance plan incorporating said content control action comprising said production plan customization instruction, the production plan implemented with said production plan customization instruction.

22. A computer-implemented method according to claim 21 and further comprising:
said user wireless computing device configured to perform:
second generating, by said user wireless computing device operating to execute said user mobile application, video output of said implementation of the performance plan incorporating said content control action comprising said production plan customization instruction, the production plan implemented with said production plan customization instruction.

23. A non-transitory computer readable medium comprising executable instructions which, when executed in a processing system, causes the processing system to perform the steps of any method of claims 12-22.
